(19) United States
(12) Patent Application Publication
(10) Pub. No.: US 2026/0111971 A1
(43) Pub. Date: Apr. 23, 2026

(54) Generative Artificial Intelligence Systems and Methods for Processing Insurance Underwriting Data

(71) Applicant: Insurance Services Office, Inc., Jersey City, NJ (US)

(72) Inventors: Nicole Ricci, Haddonfield, NJ (US); Jonathan Chandranathan, Lynbrook, NY (US); Kevin Kokoszka, Hoboken, NJ (US)

(73) Assignee: Insurance Services Office, Inc., Jersey City, NJ (US)

(21) Appl. No.: 19/361,469

(22) Filed: Oct. 17, 2025

Related U.S. Application Data
(60) Provisional application No. 63/709,049, filed on Oct. 18, 2024.

(51) Int. Cl. G06Q 40/08; H04L 51/02

(52) U.S. Cl. CPC G06Q 40/084; G06Q 40/08222; G06Q 40/09; H04L 51/02

(57) ABSTRACT

Generative artificial intelligence systems and methods for processing insurance underwriting data are provided. The system automatically ingests disparate underwriting data of varying degrees of complexity, deconstructs such files and maps them to a standardized object format, assesses the accuracy and completeness of the mapping, and automatically performs repetitive underwriting data processing tasks using customized generative AI processing techniques. The system automatically pre-fills missing fields from structured and unstructured data, completes data fields that are required for underwriting data processing, validates existing fields from submissions, scores submitted data for completeness, and determines whether the data is in condition for submission to an insurance carrier for processing. The system also provides a conversational AI chat interface which allows underwriters to ask questions of the system as information is being processed. The system accelerates processing of underwriting data and uncovers patterns in data that can be used to refine future decision-making and/or processes.

### RELATED APPLICATIONS

This application claims priority to U.S. Provisional Application Ser. No. 63/709,049 filed on Oct. 18, 2024, the entire disclosure of which is expressly incorporated herein by reference.

### BACKGROUND

### Technical Field

The present disclosure relates generally to the field of artificial intelligence. More specifically, the present disclosure relates to generative artificial intelligence systems and methods for processing insurance underwriting data.

### Related Art

In the insurance underwriting field, the ability to rapidly and accurately process insurance underwriting is of paramount concern. Indeed, the ability to efficiently and accurately process insurance underwriting tasks can significantly impact growth, market position, and other factors. Additionally, if insurance underwriting does not occur rapidly and efficiently, it can detrimentally impact individuals who wish to seek insurance by leaving assets uninsured or improperly insured.

Unfortunately, much of the work undertaken by insurance professionals during the underwriting process is manual in nature, including manually gathering and entering data relating to an asset and/or individual to be insured. Indeed, this process is inefficient, and can take days to weeks to evaluate underwriting submissions. Often, manual workflows that are undertaken during the underwriting process result in gathering of incorrect information, and/or misclassification of data. Further, while various software applications are used by insurance professionals to process underwriting submissions, such software applications are often stand-alone software applications that cannot easily communicate with each other exchange data interoperably, nor do they have adequate quality control features to ensure that incorrect and/or inaccurate information is not captured by such software applications. As a result, substantial delays in the processing of underwriting submissions occurs.

The field of general artificial intelligence has expanded substantially. Generative artificial intelligence (AI) is a subset of artificial intelligence, and utilizes generative computer models (e.g., large language models (LLMs), deep neural networks, and other types of models) to produce text, images, videos, or other forms of data in response to user inputs (e.g., prompts). Generative AI systems are trained to learn patterns input data and to generate new data in response to the learned patterns.

What would be desirable, but have not yet been provided, are generative artificial intelligence systems and methods for processing insurance underwriting data which address the foregoing and other needs.

### SUMMARY

The present disclosure relates to generative artificial intelligence systems and methods for processing insurance underwriting data. The system automatically ingests disparate underwriting data of varying degrees of complexity, deconstructs such files and maps them to a standardized object format, assesses the accuracy and completeness of the mapping, and automatically performs repetitive underwriting data processing tasks using customized generative AI processing techniques. The system automatically pre-fills missing fields from structured and unstructured data, completes data fields that are required for underwriting data processing, validates existing fields from submissions, scores submitted data for completeness, and determines whether the data is in condition for submission to an insurance carrier for processing. The system also provides a conversational AI chat interface which allows underwriters to ask questions of the system as information is being processed. The system accelerates processing of underwriting data and uncovers patterns in data that can be used to refine future decision-making and/or processes.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating a generative AI underwriting processing system in accordance with the present disclosure;

FIG. 2 is a diagram illustrating the system of FIG. 1 in greater detail;

FIG. 3 is diagram illustrating processing steps carried out by the system of the present disclosure;

FIG. 4 is flowchart illustrating processing steps carried out by the extraction engine 2 of FIG. 3;

FIG. 5 is a flowchart illustrating processing steps carried out by the engines 76-82 of FIG. 3;

FIG. 6 is a flowchart illustrating processing steps carried out by the underwriter assistant software application/interface 88 of FIG. 6 in greater detail; and

FIGS. 7-10 are screenshots illustrating various user interface screens generated by the systems and methods of the present disclosure in greater detail.

### DETAILED DESCRIPTION

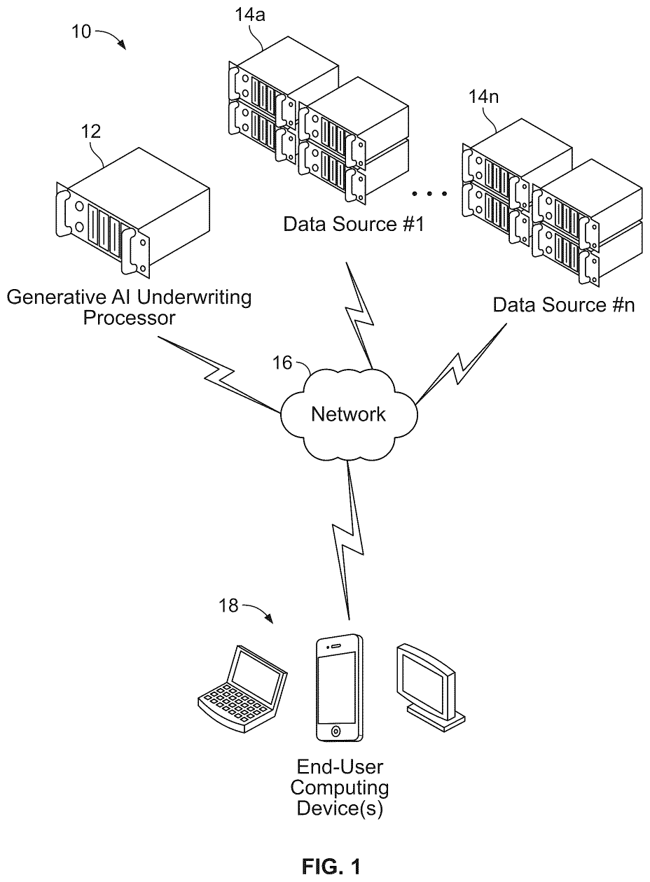

The present disclosure relates to generative artificial intelligence (AI) systems and methods for insurance underwriting, as described in detail below in connection with FIGS. 1-10.

FIG. 1 is a diagram illustrating a generative AI underwriting processing system in accordance with the present disclosure, indicated generally at 10. The system 10 includes a generative AI underwriting processor 12 which automatically processes insurance-related data provided by disparate data sources 14a-14n using generative AI components which greatly improve the speed, efficiency, and accuracy of data processing relating to insurance underwriting. In particular, the system 10 automatically identifies the complexity of potential data processing use cases, automatically ingests separate, isolated files (e.g., supplied by the disparate data sources 14a-14n) of varying degrees of complexity, automatically deconstructs such files and maps them to a standardized object format, automatically assesses the accuracy and completeness of the mapping, and automatically performs repetitive tasks, using customized generative AI processing techniques. Still further, the system 10 automatically pre-fills missing fields from structured and compiled data, automatically completes data fields required for underwriting data processing, automatically validates existing fields from submissions, automatically scores submitted data for completeness, and determines whether the data is in condition for submission to an insurance carrier for processing. As will be discussed in greater detail below, the system also provides a conversational AI chat interface which allows underwriters to ask questions of the system as information is being processed. Additionally, the system 10 accelerates processing of underwriting data (thereby reducing computer processing time and resources) and uncovers patterns in data that can be used to refine future decision-making and/or processes.

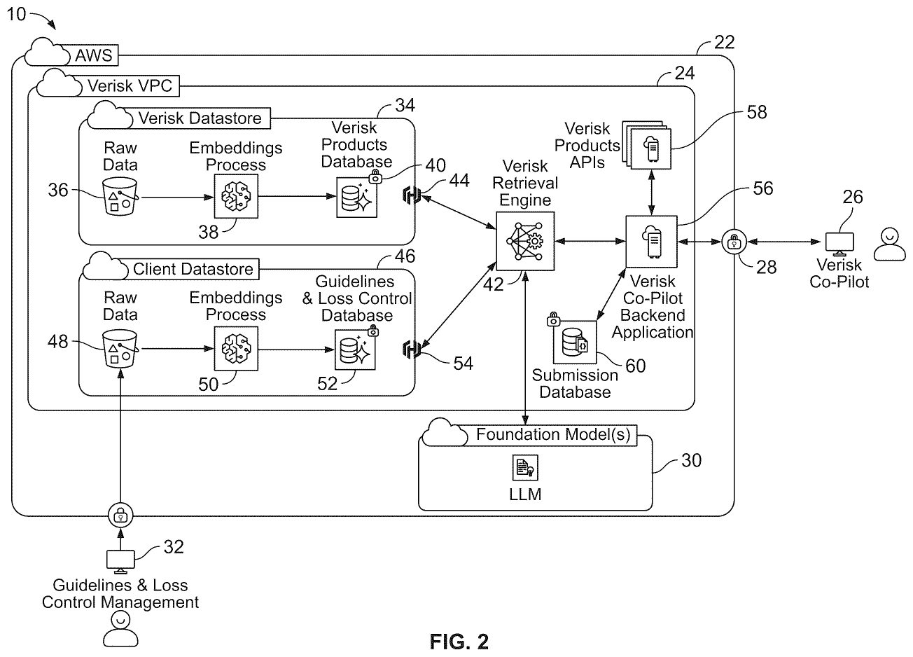

The generative AI underwriting processor 12 could comprise one or more computer systems and/or computing platforms which are programmed in accordance with the present disclosure to provide the features disclosed herein. As will be discussed in connection with FIG. 2 below, the system 10 could be implemented using one or more cloud computing platforms and associated services. The processor 12 could form part of such cloud computing platforms, and indeed, could be implemented entirely on such platforms. The processor 12 communicates with the disparate data sources 14a-14n via the network 16, which could include the Internet, a local area network, a wide area network, a cellular data network, a wireless or wired network, or any other suitable type of data communications network. The system 10 could be accessed by one or more underwriters or other users of the system using one or more end-user computing devices 18 which communicate over the network 16 with the generative AI underwriting processor 12 and/or one or more of the data sources 14a-14n. Additionally, the processor 12 (and the various cloud computing components discussed in connection with FIG. 2 below) could be programmed to perform the functions and provide the features disclosed herein as non-transitory, computer-readable instructions using any suitable high-or low-level computing language, including, but not limited to, Python, Java, Javascript, Javascript Object Notation (JSON), C, C++, C#, or any other suitable computer programming language.

FIG. 2 is a diagram illustrating the system 10 of FIG. 1 in greater detail. The system 10 could be implemented on a cloud computing platform 22 such as the AWS cloud computing platform hosted by Amazon, Inc., or any other suitable platform. In particular, one or more virtual private cloud (VPC) computing environments 24 could be instantiated in the cloud platform 22, each of which communicates with an end-user computing system 26 via a secure connection 28 (which could include, but is not limited to, a web application firewall such as the Imperva firewall). Additionally, the VPC 24 can communicate with a management computing system 32 (which could, for example, allow a systems administrator and/or project manager to issue one or more guidelines and/or loss control directives), also through a secure connection (e.g., application firewall). Still further, the VPC 24 communicates with one or more generative AI large language models (LLMs) 3M, which could be hosted by (stored on and executed by) the cloud computing platform 22.

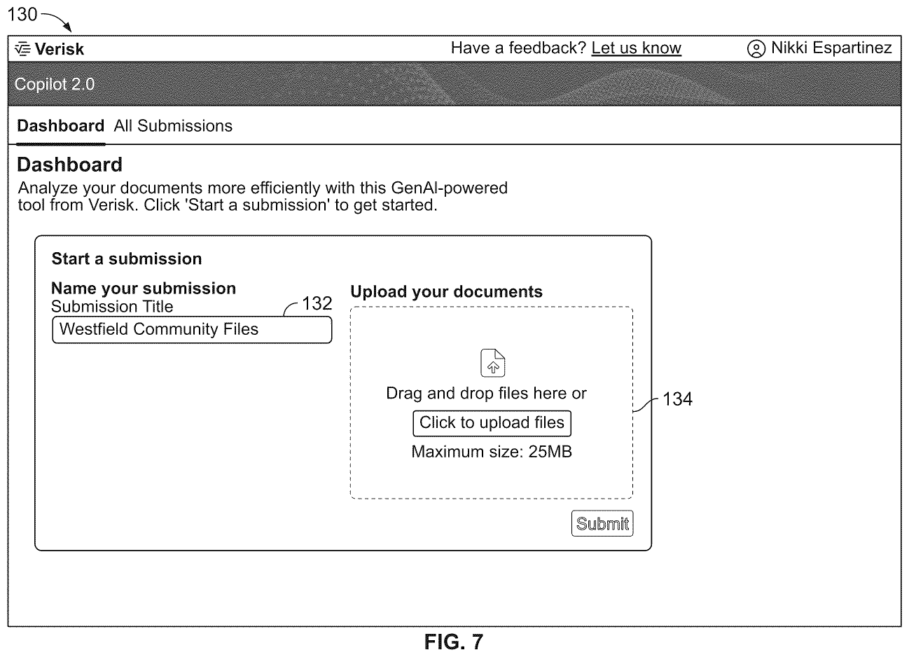

The VPC 24 includes an analytics datastore 34 that includes raw data 36 (which could be supplied by the one or more disparate data sources 14a-14n of FIG. 1), a machine learning embeddings process 38, and a database 40 that stores one or more legacy insurance data processing software products (e.g., such as those provided by Verisk Analytics, Inc.). The database 40 could be encrypted at rest using an appropriate key management service (which executes a secure encryption algorithm), such as the Key Management Service provided Amazon, Inc. The datastore 34 communicates with a retrieval engine 42 via secure data credentialing service, such as that provided by Hashicorp, Inc., which secures, stores, and tightly controls access to data and/or computing resources using dynamic credentialing techniques. The retrieval engine 42 communicates with a back-end software application 56, which provides both a user interface (described in more detail below in connection with FIGS. 7-10) and an access mechanism to the various functions and features provided by the system 10. The application 56 communicates with one or more legacy software applications via application programming interfaces (APIs) 58, each of which provides a connection between the application 56 and the legacy software application. Still further, the application 56 communicates with a secure submission database 60 which stores data to be processed relating to one or more insurance underwriting submissions.

The components shown in FIG. 2 are software components and/or databases which can communicate with each other using secure, encrypted data communications, such as TLS version 1.2 or higher. Also, an appropriate AI governance software component, such as Monitaur, could be utilized to ensure that the AI components of the system 10 (such as the LLMs 30) are compliant with one or more accepted standards, and function responsibly and as expected.

Also stored on and executed by the cloud platform 22 is a client datastore 46, which includes raw client data 48 (e.g., raw insurance data of an insurance provided, and/or associated customers and/or assets), a machine learning embeddings process 50 that processes the raw data 48 to generate machine learning embeddings, and a secure database 52 that stores information relating to guidelines and loss control. The datastore 46 communicates with the retrieval engine 42 using a secure, dynamic credentialing service, such as the aforementioned Hashicorp service.

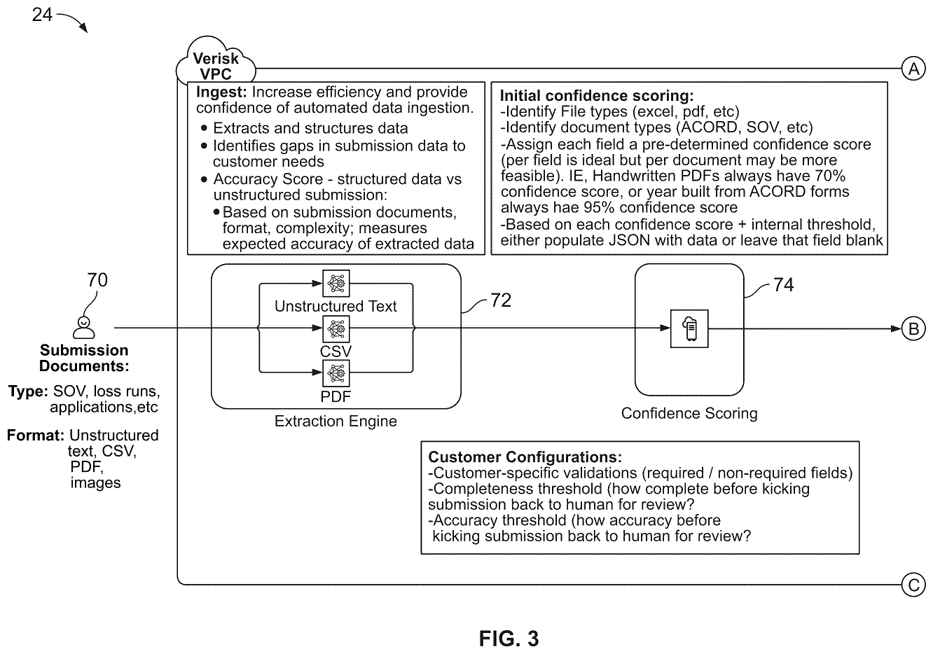

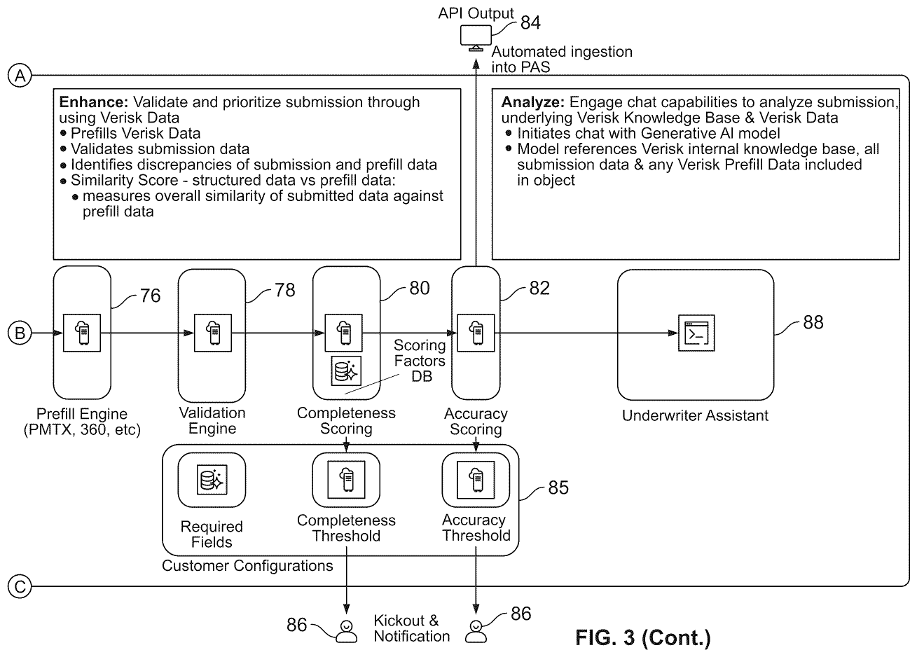

FIG. 3 is diagram illustrating processing steps, indicated at 70, carried out by the VPC 24 of FIG. 1. An extraction engine 72 obtains insurance underwriting submission data from a user 70, which can be in disparate, incompatible formats such as unstructured text, comma-separated value (CSV) data, and Portable Document Format (PDF) data. Such data can also be supplied from the one or more disparate data sources 14a-14n of FIG. 1, which are in communication with the VPC 24, and/or from the submission database 60 of FIG. 2. The submission data can include, but is not limited to, statement of values (SOV) data, loss runs, associated applications, etc. The engine 72 ingests the submission data through an automated process which extracts and structures the data, identifies any missing data or gaps in required data (which could be specified in advance by a user), and scores the accuracy of the submission data based on the submission documents, format, or complexity. The score indicates the expected accuracy of the extracted data.

Output of the extraction engine 72 is processed by the confidence scoring module 74, which performs initial confidence scoring on the extracted information. More specifically, the module 74 identifies file types, identifies document types, assigns each field a pre-determined confidence score (which could be assigned for each field or for the entire document—e.g., handwritten PDF files could always have a 70% confidence score assigned to them, if desired, or forms from ACORD could be assigned a higher (e.g., 95%) confidence score). Based on the confidence score and one or more internal thresholds, the module 74 could populate a JSON message with the extracted data, or it could leave a specific field blank.

When confidence scoring by the module 74 is complete, engines 76-82 are executed, including prefill engine 76, validation engine 78, completeness scoring engine 80, and accuracy scoring engine 82. The prefill engine 76 automatically pre-fills the underwriting submission with insurance analytics data from one or more analytics providers, such as Verisk Analytics, Inc. The validation engine 78 validates the submission data and identifies discrepancies between the submission data and the insurance analytics (pre-fill) data. The completeness scoring engine 80 calculates a similarity score between the structured data and the pre-fill data, which measures the overall similarity of the submitted data and the pre-fill data. This engine could access a scoring factors database. The accuracy scoring engine 82 calculates a final score indicating the overall accuracy of the submission data, which can be communicated via an API output 84 to one or more software systems in communication with the API 84, for further processing. The underwriting submission, including the scores generated by the engines 80-82, are accessible via an underwriter assistant software application/interface 88, which allows a user of the system to engage in generative AI chat capabilities with the LLMs 30 of FIG. 2 to analyze the submission. The LLMs 30 are specially-trained language models that reference an internal knowledge base, all of the underwriting submission data processed by the system 10, as well as any pre-fill data automatically included by the pre-fill engine 76 into the submission, in order to conduct the chat with the user and to guide analysis of the underwriting submission.

The VPC 24 also includes a plurality of customer configurations 85, which are customer-specific data and/or settings such as customer-specific validations (which indicate required or non-required fields in each submission for that customer), completeness thresholds (which indicate how complete a submission must be before involving human review), and accuracy thresholds (which indicate how accurate a submission must be before involving human review). Notifications 86 could then be generated and sent to users indicating whether the customer configurations are being met and/or require adjustment.

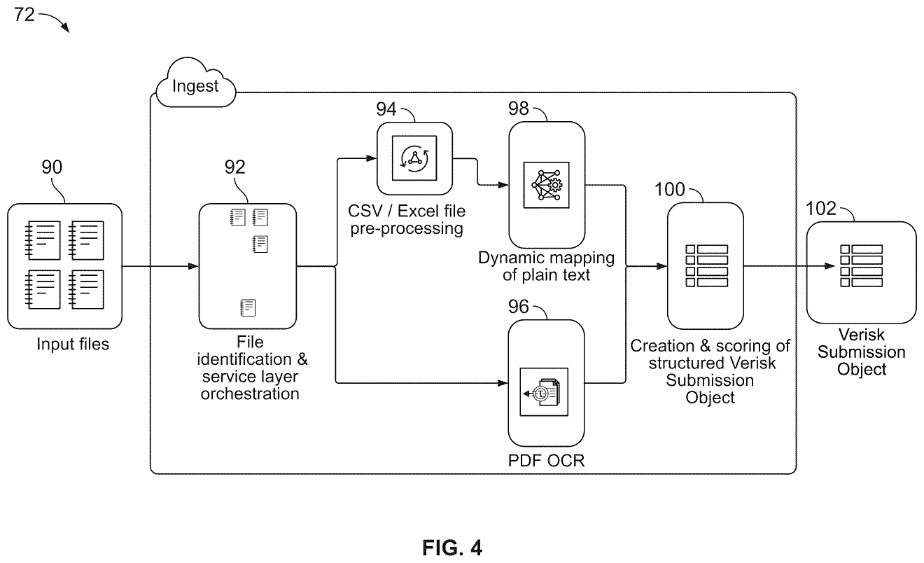

FIG. 4 is flowchart illustrating processing steps performed by the extraction engine 72 of FIG. 3. In step 90, the various input files discussed in connection with FIG. 3 are obtained by the system, and in step 92, the engine 72 identifies each file and performs service-layer orchestration for each file (e.g., identifying what specific types of extraction processing steps are required for each file type). If the file type is a CSV or Microsoft Excel file type, step 94 occurs, wherein the file is pre-processed. Then, in step 98, the engine 72 performs dynamic mapping of plain text present in the file. If the file type is a PDF file, step 96 occurs, wherein the system performs optical character recognition (OCR) on the PDF and extracts plain text from the file. In step 100, the module 72 creates and scores a submission object 102, which is a unified data structure that is used by the system to process all underwriting submissions. Advantageously, the submission object permits the system 10 to rapidly and efficiently process underwriting submission data even though the underlying data forming the basis of an underwriting submission originates in disparate (and often, incompatible) formats. For example, the submission object can tolerate wide ranges of disparity and complexity in the input data, such as simple complexity (e.g., documents that are straightforward, are in black and white, are full of context, and are well-structured) to moderate complexity (e.g., somewhat unclear documents/data, only partial context available, and the presence of shorthand or abbreviations in the documents/data) to complex (e.g., messy documents/data, extremely ambiguous data, multiple misspellings, and no structure). The submission object is a custom data structure that includes a plurality of fields which allow for unified processing of data from disparate data sources. The fields of the data structure could include, but are not limited to, a submission document source field which identifies the data source of a particular document in the submission (e.g., ACORD, SOV, loss run data source, etc.), a group field which indicates which broader component a field belongs to, a field name which identifies the field, a boolean (e.g., yes/no) field indicating whether the field in question is required for the underwriting submission, and a comments field which provides detailed information about the field.”

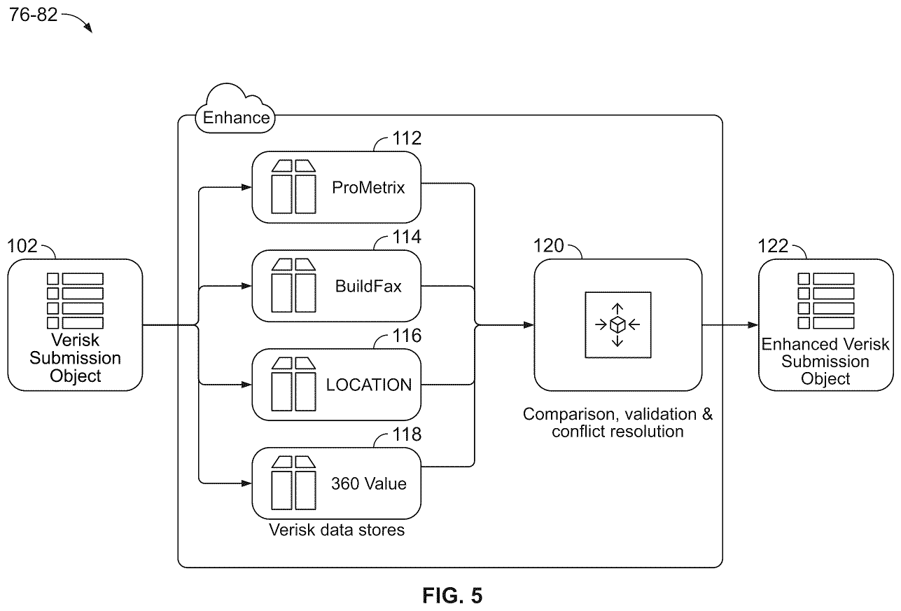

FIG. 5 is a flowchart illustrating processing steps carried out by the engines 76-82 of FIG. 3. The submission object 102 generated by the extraction engine 72 is processed in step 120 against one or more data stores, including the ProMetrix data store 112, the BuildFax data store 114, the Location data store 116, and the 360 Value data store 118, in order to determine the accuracy and completeness of the submission object 102 against each of the data stores. More specifically, each field of the object 102 is checked to verify that it is complete and complies with one or more requirements of the data stores 112-118. If any conflicts are identified in step 120, they are resolved, and if any required data (required by the data stores 112-118) is missing, the system automatically supplies the missing data, producing an enhanced submission object 122.

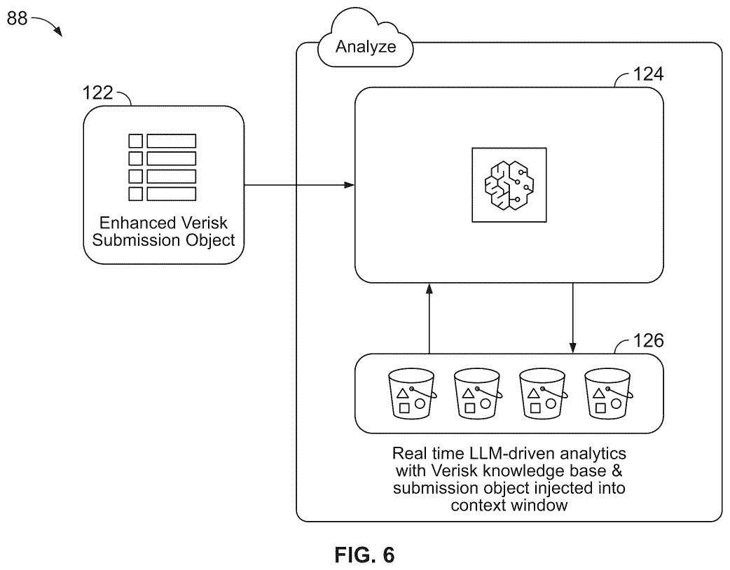

FIG. 6 is a flowchart illustrating steps carried out by the underwriter assistant software application/interface 88 of FIG. 6. The enhanced submission object 122 is analyzed by engine 124 and displayed in a context window (described in more detail below in connection with FIGS. 7-10), along with a generative AI chat interface. The object 122 analyzed with reference to analytics 126 that are driven by the LLMs 60 of FIG. 2 (which are trained on the underwriting submission data handled by the system 10), and includes content injected into the submission by the system 10.

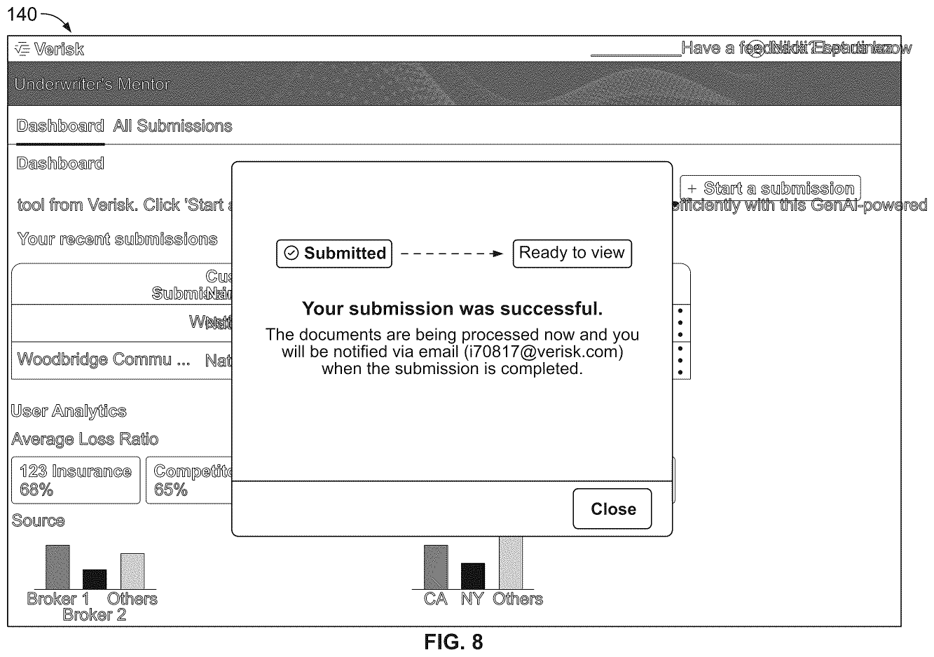

FIGS. 7-10 are screenshots illustrating various user interface screens generated by the systems and methods of the present disclosure in greater detail. More specifically, the screenshots shown in FIGS. 7-10 are generated by the underwriter assistant software application/interface 88, and allow for real-time analytics of the submission object generated by the system 10. FIG. 7 is a screenshot of the main interface screen 130, which provides a dashboard that allows the user to name an underwriting submission for processing by the system using title field 132, and to upload both structured and unstructured files associated with the submission using a drag-and-drop file upload portal 134. As shown in FIG. 8, once the submission is named and the files are uploaded, screen 140 is displayed, indicating successful uploading of the submission. The user is notified that the submission will be processed by the system 10, and that the user will be notified (e.g., via an e-mail) when processing of the submission is complete.

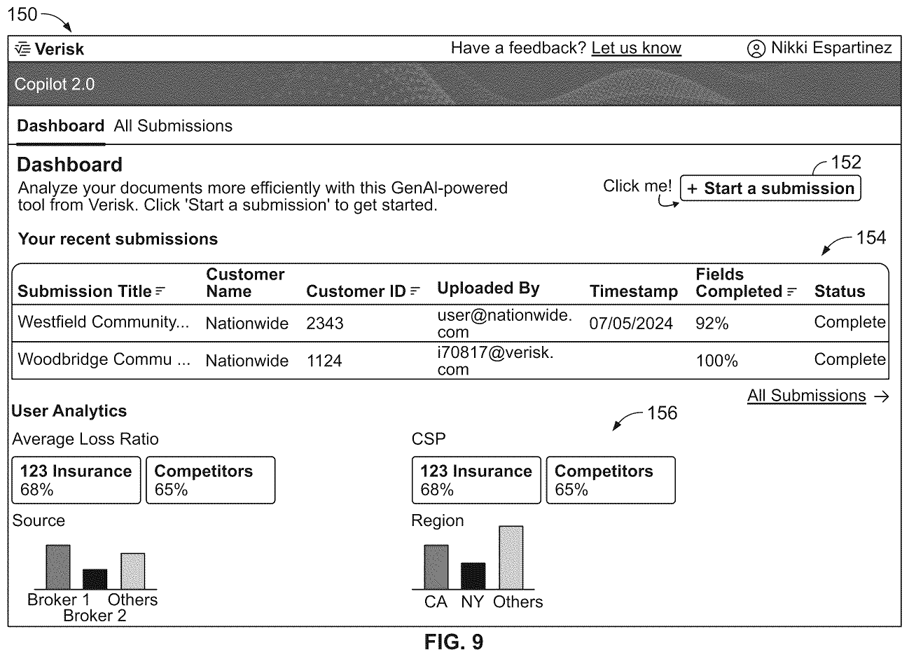

FIG. 9 is a screenshot of the main analytics screen 150 generated by the application 88, once a submission has been processed by the system. The screen 150 allows the user to start a submission by clicking the submission button 152, monitor the status of submissions already submitted via status panel 154, and view current analytics for the user via analytics display panel 156. The display panel 156 could display information specific to the user, such as average loss ratios, sources of such losses (e.g., brokers), and commercial statistical plan (CSP) percentages for the user, which could be summarized by territories (e.g., by states).

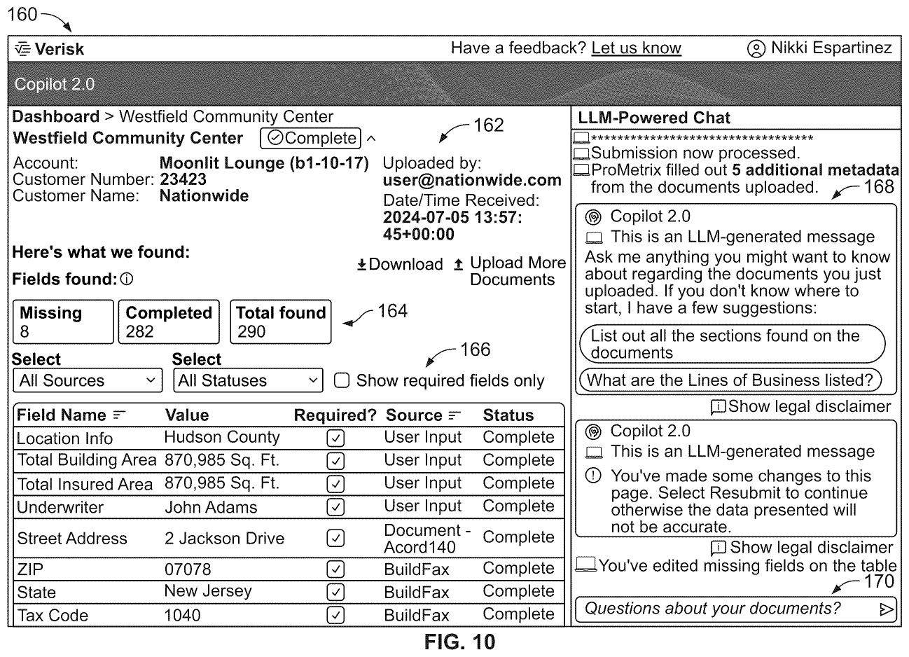

FIG. 10 is a screenshot of submission analytics screen 160, which provides detailed analytics information for a particular underwriting submission. The screen 160 includes a submission summary panel 162 which summarizes information about a specific underwriting submission such as the asset/facility/individual (to be underwritten) name, account name, customer number, identity of the uploader, date/time received, and customer name. Panel 164 displays tallies of all missing data fields automatically identified in the submission, total completed data fields, and total number of data field. Pull-downs allow the user to select data sources which drive the tallies, as well as all specific statuses to be displayed. The user can also choose to download the submission and/or upload additional documents to the system 10.

Detailed field information panel 166 lists specific fields within the submission, as well as the values of such fields, an indication of whether such fields are required, the source of data for such fields (e.g., from user input, from a document, from a data source in communication with the system (e.g., BuildFax data source), etc.), and an indication of the status for that field (e.g., whether the field is complete or incomplete, or other status). An AI chat panel 168 allows the user to converse with the system and to ask specific questions relating to the submission using a conversational prompt interface, using prompt input field 170. For example, the user can ask the system 10 to identify all sections that are found in the documents, what lines of business are listed in the documents, etc., and the system provides generative AI responses to such prompts. Additionally, the AI chat panel 168 could automatically generate messages for the user, such as identifying when changes have been made by the user and suggesting courses of action that should be taken to avoid incomplete or inaccurate data.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A generative artificial intelligence (AI) system for insurance underwriting, comprising:
a processor in communication with a plurality of data sources;
an extraction engine executed by the processor, the extraction engine obtaining insurance underwriting submission data in disparate formats and generating a submission object from the insurance underwriting submission data, the submission object comprising a unified data structure for processing the disparate formats of the insurance underwriting submission data;
a confidence scoring module executed by the processor, the confidence scoring module processing output of the extraction engine and generating an initial confidence score based on data extracted by the extraction engine;
a prefill engine executed by the processor, the prefill engine automatically pre-filling the insurance underwriting submission data with insurance analytics data;
a validation engine executed by the processor, the validation engine validating the insurance underwriting submission data and identifying discrepancies between the insurance underwriting submission data and the insurance analytics data;
a completeness scoring engine executed by the processor, the completeness scoring engine calculating a similarity score between structured data and the insurance analytics data;
an accuracy scoring engine executed by the processor, the accuracy scoring engine calculating a final score indicating an overall accuracy of the insurance underwriting submission data; and
an underwriter assistant software application executed by the processor, the underwriter assistant software application allowing access to the insurance underwriting submission data, the similarity score, and the final score, the underwriting assistant software application generating a generative artificial intelligence chat panel, the generative artificial intelligence chat panel in communication with a plurality of large language models (LLMs) and allowing a user of the underwriter assistant software application to engage in a chat for guiding analysis of the insurance underwriting submission data.

2. The system of claim 1, wherein the insurance underwriting submission data is obtained by the system from the plurality of data sources or from a user in communication with the system.

3. The system of claim 2, wherein the insurance underwriting submission data comprises at least one of unstructured text, comma-separated value (CSV) data, or portable document format (PDF) data.

4. The system of claim 1, wherein the extraction engine identifies missing data or gaps in required data from the insurance underwriting submission data.

5. The system of claim 4, wherein the extraction engine scores accuracy of the insurance underwriting submission data.

6. The system of claim 1, wherein the confidence scoring module identifies file type and document types from the insurance underwriting submission data and assigns each field of the insurance underwriting submission data a pred-determined confidence score.

7. The system of claim 1, wherein the completeness scoring engine accesses a scoring factors database.

8. The system of claim 1, wherein the submission object further comprises a plurality of fields including a submission document source field identifying a source of a document, a group field indicating a component to which a field belongs, a field name, a Boolean field indicating whether a question is required for the insurance underwriting submission data, and a comments field.

9. The system of claim 1, wherein the extraction engine compares the submission object to a plurality of data stores to determine accuracy and completeness of the submission object.

10. The system of claim 1, wherein the underwriter assistant software application displays a main analytics screen allowing the user to generate a submission for analysis, monitor a status of a submission already submitted to the system, and view current analytics relating to a submission.

11. The system of claim 10, wherein the main analytics screen displays average loss ratios, sources of losses, and commercial statistical plan percentages.

12. The system of claim 10, wherein the underwriter assistant software application displays a submission analytics screen summarizing information about an insurance submission, missing data fields identified by the system in the submission, total completed data fields, and total number of data fields.

13. A generative artificial intelligence (AI) method for insurance underwriting, comprising:
obtaining by an extraction engine executed by a processor insurance underwriting submission data in disparate formats;
generating by the extraction engine a submission object from the insurance underwriting submission data, the submission object comprising a unified data structure for processing the disparate formats of the insurance underwriting submission data;
processing by a confidence scoring module executed by the processor output of the extraction engine and generating an initial confidence score based on data extracted by the extraction engine;
automatically pre-filling by a prefill engine executed by the processor the insurance underwriting submission data with insurance analytics data;
validating by a validation engine executed by the processor the insurance underwriting submission data and identifying discrepancies between the insurance underwriting submission data and the insurance analytics data;
calculating by a completeness coring engine executed by the processor a similarity score between structured data and the insurance analytics data;
calculating by an accuracy scoring engine executed by the processor a final score indicating an overall accuracy of the insurance underwriting submission data; and
allowing access to the insurance underwriting submission data, the similarity score, and the final score in an underwriter assistant software application executed by the processor, the underwriting assistant software application generating a generative artificial intelligence chat panel, the generative artificial intelligence chat panel in communication with a plurality of large language models (LLMs) and allowing a user of the underwriter assistant software application to engage in a chat for guiding analysis of the insurance underwriting submission data.

14. The method of claim 13, further comprising obtaining the insurance underwriting submission data from the plurality of data sources or from a user in communication with the system.

15. The method of claim 14, wherein the insurance underwriting submission data comprises at least one of unstructured text, comma-separated value (CSV) data, or portable document format (PDF) data.

16. The method of claim 13, further comprising identifying by the extraction engine missing data or gaps in required data from the insurance underwriting submission data.

17. The method of claim 16, further comprising scoring by the extraction engine accuracy of the insurance underwriting submission data.

18. The method of claim 13, further comprising identifying by the confidence scoring module file types and document types from the insurance underwriting submission data and assigning each field of the insurance underwriting submission data a pred-determined confidence score.

19. The method of claim 13, further comprising accessing by the completeness scoring engine a scoring factors database.

20. The method of claim 13, wherein the submission object further comprises a plurality of fields including a submission document source field identifying a source of a document, a group field indicating a component to which a field belongs, a field name, a Boolean field indicating whether a question is required for the insurance underwriting submission data, and a comments field.

21. The method of claim 13, further comprising comparing by the extraction engine the submission object to a plurality of data stores to determine accuracy and completeness of the submission object.

22. The method of claim 13, further comprising displaying by the underwriter assistant software application a main analytics screen allowing the user to generate a submission for analysis, monitor a status of a submission already submitted to the system, and view current analytics relating to a submission.

23. The method of claim 22, wherein the main analytics screen displays average loss ratios, sources of losses, and commercial statistical plan percentages.

24. The method of claim 22, further comprising displaying by the underwriter assistant software application a submission analytics screen summarizing information about an insurance submission, missing data fields identified by the system in the submission, total completed data fields, and total number of data fields.
